(19) United States
(12) Patent Application Publication
(10) Pub. No.: US 2011/0310443 A1
(43) Pub. Date: Dec. 22, 2011

(54) DEVICE AND METHOD FOR SCANNING LARGE-FORMAT DOCUMENTS

(76) Inventors: Stephan Frisch, Weitefeld (DE); Simon Kaempflein, Friedewald (DE); Victor Hildebrandt, Kirchen (DE)

(21) Appl. No.: 13/203,725

(22) PCT Filed: Mar. 2, 2010
(86) PCT No.: PCT/EP10/01271

§ 371 Date: Aug. 27, 2011

(30) Foreign Application Priority Data
Mar. 10, 2009 (DE) 10 2009 011 945.0

(51) Int. Cl. H04N 1/40

(52) U.S. Cl. 358/449

(57) ABSTRACT

A method for scanning large-format documents by way of a large-format scanner, which is connected to a PC (11) via a standard interface (10), is to be further developed, so as to omit prescans, to optimize the scanning rate, to significantly increase productivity between the application of the document and the storage of the data on the PC, and to obtain cost-efficient scans. It is disclosed that upon inserting (1) the documents into the large-format scanner a broadness detection (2) takes place, depending on said broadness detection (2) areas of at least one image detection element which are not required because said areas are not confronted with the document will be turned off (3) in order to reduce the band width of the scanned data, the document will be scanned (7), the scanned data will be transmitted via the standard interface (10), a continuous control of the maximum amount of data which can be transmitted takes place during data transfer (10) and depending on the control result the rate of the document feeding is affected.

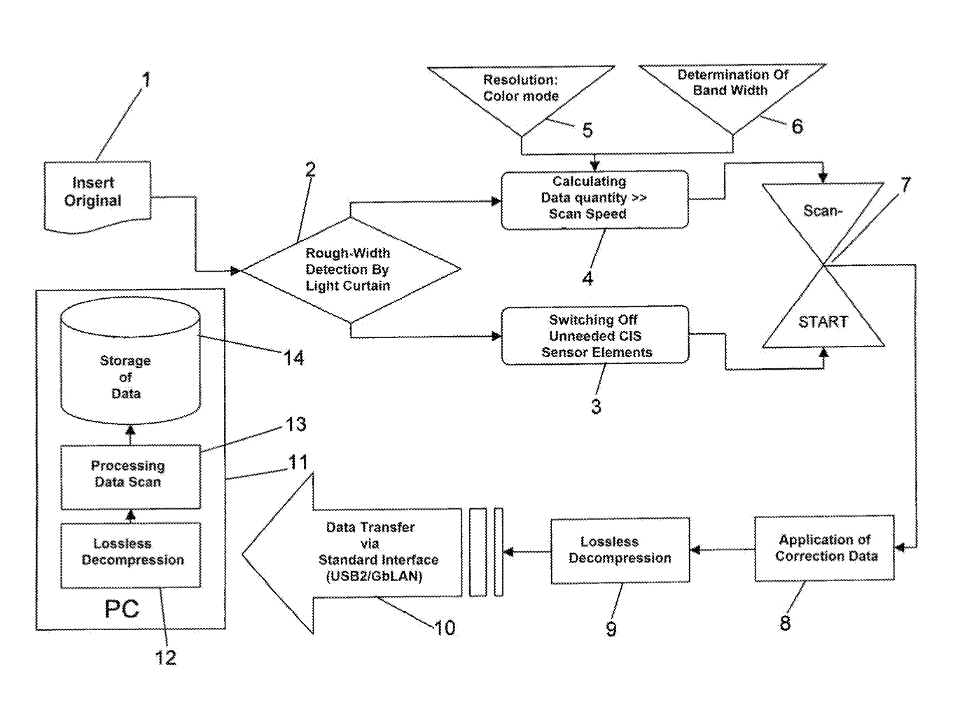

The invention relates to an apparatus and a method of scanning large-format documents with a large-format scanner that is connected to a PC via a standard interface.

Large-format scanners are known that have an integrated computer that has corresponding input channels according to the number of channels of, for example contact-image sensors or CCD cameras of the large-format scanner. This computer can process all incoming data so quickly that high scanning speeds are possible.

However, for cost reasons, a large-format scanner is often not provided with a complex integrated computer, instead PC's provided on site are to be used for recording and storing the scanned data. It has proven to be a disadvantage here that only a specific data quantity can be transferred via the interface between the large-format scanner and the PC. Since with large-format scanners with large document widths there are correspondingly large quantities of data that have to be transmitted simultaneously, the scanners are run in steps or operated only very slowly during the scan process so that all the data can be transferred without losses. In order to be able to determine the data quantity beforehand, so-called prescans are carried out in the case of such scanners and the speed of the scanner is set depending on the data quantity to be expected as determined by the prescan. The disadvantage with this is that on the one hand time must be taken for the prescan and on the other hand effort must be made to move back the document after the prescan in order to be able to start the actual scan.

US 2009/0040560 discloses a scanning apparatus in which the scanned images are first stored in an internal memory. The stored data can be transferred from the memory to a computer. The scanner unit is stopped or started again depending on the free capacity of the scanner memory. It is furthermore disclosed that, according to U.S. Pat. No. 6,648,226, instead of stopping and starting the document feed again, a speed control for the document feed is possible.

From DE 690 25 751 [5,053,885], document recognition techniques for copier apparatuses are known where the size and the position of the document can be recognized automatically.

JP 63-7076A also discloses a scanner unit with document recognition where avoiding the transfer of unnecessary data and shortening the reading time are achieved by carrying out a restriction to the necessary width and length of the document.

The object of the invention is to further develop an apparatus and a method of scanning large-format documents such that prescans are eliminated, the scan speed is optimized, a clear increase in productivity is achieved between initial placement of the document and storage of the data in the PC so that cost-effective scans result.

In terms of the apparatus, the object is attained in that a device for detecting the width of the document is provided in the document path of the large-format scanner, that the width-detecting device is connected to an electric circuit that in turn is connected to at least one image-capturing element of the large-format scanner, that at least some of the image-capturing elements can be switched off depending on the detected document width, that a device for continuously determining the maximum transmission bandwidth of the standard interface is provided, that the width-detection device is connected to a drive for the documents, and that the speed of the document drive can be adjusted depending on the output signals of the width-detection device.

It has proven to be advantageous that the device for detecting the width of the document is a photoelectric curtain. Such a photoelectric curtain operates quickly and without contact. It does not impede the scanning process. Of course, microswitches or also side gauges provided with position sensors or the like can also be used as the document-width detector.

It has proven useful thereby that the photoelectric curtain sensors at least on one side of the center of the document path are set at increasingly smaller spacings. The document can be centered by prior adjustment of side gauges or the like. As a result it is not necessary for the photoelectric curtain to extend across the entire width of the scanner. However, the photoelectric curtain can also extend across the entire width of the scanner so that a centering between side gauges can be omitted. Due to the increasing spacings between the photoelectric curtain, in the outer region where the edges of the large-format documents are regularly to be found, the format can be determined with higher accuracy than in the center of the document feeder. Of course, it is also conceivable to set [the image-capturing elements of] the photoelectric curtain at uniform spacings from one another, preferably at spacings that are as small as possible.

It has proven advantageous when the image-capturing element is composed of contact image sensors (CIS). Here not only can the contact image sensors be switched off individually, it is also possible to switch off individual channels of contact image sensors in order to restrict the data quantity in as optimum a manner as possible.

The object on which the invention is based is achieved in terms of the method in that a width of the document is detected when the document is initially placed in the large-format scanner, that, depending on the detected width, regions of at least one image-capturing element that are not required because they do not confront the document are switched off to reduce the bandwidth of the scanned data, that the document is scanned, that the scanned data is transferred via the standard interface, that the maximum transferrable data quantity is continuously monitored during the data transfer and that the speed of the document feed is adjusted depending on the monitoring result.

Already during initial placement of the document, its width is detected and the unneeded regions of the image-capturing element detecting the entire width of the large-format scanner are switched off. Thus no data is scanned in those regions in which no document is recognized, so that from the start essentially only data is scanned that actually belong to the document. That is, all of the data is not detected over the entire width of the scan lines and transferred to the computer, as is otherwise usual. This means that the data quantity is regularly reduced. Of course, if the document format is known, it can be possible to switch off some sections of the image-capturing element likewise via the input of the document format. Before the actual scan process, the actual data quantity is determined at the same time as switching off the image-capturing elements, and the feed rate for the document is calculated from this data quantity and depending on the determined maximum transferrable data quantity.

It has proven useful that the maximum transmission bandwidth of the standard interface is determined before the scan start, preferably automatically, and the result is used for presetting the speed of the document feed.

That is, already when switching on the scanner and the PC what quantities of data can be transferred as a maximum via the interface are determined. According to the maximum transferrable data and knowing the document width, the scanning speed with which the data is recorded can be calculated so that, for example, the recorded data quantity does not exceed the bandwidth of the data simultaneously transferred to the PC due to excessively high scan speeds, and that a scanning speed that is too low, which would render the large-format scanner ineffective, is not set either.

It has proven to be useful that the width detection is carried out as a rough width detection by the photoelectric curtain.

It is advantageous that, depending on the width detection, regions of the image-capturing element that are not required are switched off before the scan process is started.

Through the ability to switch off individual regions of the image-capturing element, it is possible for the total width of the image-capturing element to be adapted in the best possible manner to the detected document width, so that in fact only that data is recorded that comes from the document. Regions outside the document, in contrast to the prior art, are essentially not scanned at all, so that no data is collected here.

It is advantageous that black/white calibration data is applied to the scanned data during the scan process. It is also advantageous that the scanned data is corrected.

It has also proven to be useful to compress the scanned data and then transfer it via the standard interface in the compressed state. Thus more data can be transferred via the interface so that more data can be recorded and the speed of the large-format scanner is increased.

It has proven to be useful when compression is carried out losslessly in real time.

The data transfer is preferably monitored continuously and the speed of the scanner is corrected depending on the monitoring result.

Due to the other uses of the PC, the maximum bandwidth of the data to be transferred can change. With appropriate correction, the scan speed can be adapted to the changing bandwidth. This can go so far that the document feed is stopped and is started again at a lower speed.

According to the invention the data is decompressed and stored in the PC.

Advantageously, the scanned or stored data is refined using filters and are outputted in this refined form or stored in the desired target format.

The invention is explained in more detail with reference to a drawing. The figure thereof is a flow chart showing the individual process steps.

First, the original document is inserted at 1. The width detection is carried out at 2, for example rough width detection via photoelectric curtain. Depending on the width recognition 2, regions of the image-capturing elements, in this case CIS elements or individual channels of the CIS elements, not needed are switched off at 3. At the same time scan speed is determined at 4, depending on width detection 2 and the data quantity to be expected given the document width. This calculation includes furthermore data such as resolution, color mode 5 and the determination of the bandwidth 6. Now the scan start 7 takes place.

Correction data, such as black/white calibration data, are applied to the data determined in the scan process at 8. The correspondingly corrected scanned data is compressed in a lossless manner at 9. Thereafter data transfer 10 takes place via standard interfaces such as for example USB/2 or gigabit-LAN interfaces. Lossless data decompression 12 takes place in a PC 11. This is followed by a processing 13 of the scanned data, for example the brightness, the sharpness, the stitching, etc. are refined using filters. The data processed in this manner are stored at 14.

### OVERVIEW OF REFERENCE NUMBERS

1 Insert document

2 Width detection

3 Switch off

4 Determination of scan speed

5 Resolution color mode

6 Determination of bandwidth

7 Scan start

8 Application of correction data

9 Lossless compression

10 Data transfer

11 PC

12 Decompression

13 Data processing

14 Data storage

1. An apparatus for scanning large-format documents with a large-format scanner that is connected to a PC via a standard interface, wherein
a device for detecting the width of the document is provided in the document path of the large-format scanner,
the width-detecting device is connected to an electric circuit,
the electric circuit is connected to at least one image-capturing element of the large-format scanner,
the image-capturing element can be switched off at least in some sections depending on the document width detected,
a device for continuously determining the maximum transmission bandwidth of the standard interface is provided,
the width-detection device is connected to a drive for the documents, and
the speed of the document drive can be adjusted depending on output signals of the width-detection device.

2. The apparatus according to claim 1, wherein the device for detecting the width of the documents is a photoelectric curtain.

3. The apparatus according to claim 2, wherein image-capturing elements of the photoelectric curtain at least on one side of the center of the document path are set at spacings that decrease.

4. The apparatus according to claim 1, wherein the image-capturing elements are contact image sensors.

5. A method of scanning large-format documents with a large-format scanner that is connected to a PC via a standard interface, wherein
a width detection of the document is carried out when the document is placed in the large-format scanner,
depending on the width detection, regions of at least one image-capturing element that are not required because they do not confront the document are switched off to reduce the to bandwidth of the scanned data,
the document is scanned,
the scanned data is transferred via the standard interface,
the maximum transferrable data quantity is continuously monitored during the data transfer, and
the speed of the document feed is adjusted depending on the monitoring result.

6. The method according to claim 5, wherein the maximum transmission bandwidth of the standard interface is determined before the scan start and the result is used for presetting the speed of the document feed.

7. The method according to claim 5, wherein the width detection is carried out as a rough width detection by a photoelectric curtain.

8. The method according to claim 5, wherein depending on the width detection, regions of the image-capturing element that are not required are switched off before the start of the scan process.

9. The method according to claim 5, wherein black/white calibration data is applied to the scanned data during the scan process.

10. The method according to claim 5, wherein the scanned data is corrected and thereafter is transferred via the standard interface.

11. The method according to claim 10, wherein the scanned data is compressed.

12. The method according to claim 11, wherein the compression is carried out losslessly and in real time.

13. The method according to claim 6, wherein data transfer is monitored continuously and a predetermined speed of the document feed is corrected depending on the monitoring result.

14. The method according to claim 12, wherein the data is decompressed and stored in the PC.

15. The method according to claim 14, wherein the scanned or stored data is refined using filters and the refined data is read out and/or stored in a desired target format.
